(19) United States
(12) Patent Application Publication
(10) Pub. No.: US 2011/0285642 A1
(43) Pub. Date: Nov. 24, 2011

(54) Touch Screen

(75) Inventors: Hee Bum LEE, Gyunggi-do (KR); Kyoung Soo CHAE, Gyunggi-do (KR); Yong Soo OH, Gyunggi-do (KR); Jong Young LEE, Gyunggi-do (KR)

(73) Assignee: SAMSUNG ELECTRO-MECHANICS CO., LTD., Gyunggi-do (KR)

(21) Appl. No.: 12/838,399

(22) Filed: Jul. 16, 2010

(30) Foreign Application Priority Data
May 19, 2010 (KR) 10-2010-0046912

(51) Int. Cl. G06F 3/041

(52) U.S. Cl. 345/173

(57) ABSTRACT

Disclosed herein is a touch screen that includes: a first touch screen part that is positioned on an upper part of a display to detect external contact of an input device and compute absolute coordinate information of a contact point and includes two substrates having electrodes patterns that are spaced by a spacer and face each other; and a second touch screen part that is connected with the first touch screen part to measure the change in capacitance by the external contact of the input device and compute vector coordinate information of the input device.

### CROSS REFERENCE TO RELATED APPLICATION

This application claims the benefit of Korean Patent Application No. 10-2010-0046912, filed on May 19, 2010, entitled “Touch Screen”, which is hereby incorporated by reference in its entirety into this application.

### BACKGROUND OF THE INVENTION

1. Technical Field

The present invention relates to a touch screen.

2. Description of the Related Art

A touch screen, as an input instrument inputting a corresponding command by pressing icons displayed on a terminal with a finger or an input device such as a stylus pen, is extensively used in various fields.

In general, with the development of a mobile communication technology, terminals such as a cellular phone, a PMP, a PDA, and a navigation system are extending their functions as a composition apparatus providing more various and complicated multimedia such as audio, a moving picture, a wireless Internet web browser, etc., in addition to a simple text information display apparatus. Therefore, a touch screen in which a larger display screen can be implemented within a limited terminal size has become more popular as the input instrument.

FIG. 1 illustrates a cellular phone 10 which is a terminal adopting a touch screen in the prior art. The cellular phone 10 includes a communication unit, a system control unit, a broadcast receiving unit, a sound input/output unit, a display, etc., therein. A touch screen 11 is positioned on an upper part of a display mounted in the cellular phone, which configures the exterior of the cellular phone. An image generated in the display may include various icons. When a control unit extracts absolute coordinate information of a contact point and transmits it to the system control unit controlling an entire system of the cellular phone in the case in which a user selects any icon through an input device, the display provides an application corresponding to the selected icon.

Terminals that have recently been launched on the market have functions similar to personal computers, but have sizes smaller than the personal computers in respect to design. Therefore, a variety of information is provided to the display and fine tuning is needed to select information required by the user.

In particular, while a smart mobile phone is being developed and a GUI (Graphic User Interface) environment such as Windows is being applied to the smart mobile phone, fine tuning required by the user is limited in the touch screen in the prior art.

In order to solve the problem, a smart mobile phone that has been recently developed is additionally provided with a pointing device 12 such as an optical pointing device at one side of the mobile phone as shown in FIG. 1. Such an optical pointing device includes a light emitting unit and an image sensor. When light emitted from the light emitting unit is reflected on an input unit and inputted into the image sensor, the optical pointing device extracts displacement information of the input unit responding to the change of the light inputted into the image sensor. In addition, the optical pointing device controls a pointer 13 displayed on the display depending on the displacement information.

The pointing device 12 can be finely tuned in order to select an icon required by the user. However, since the pointing device 12 is expensive and is additionally mounted in the terminal regardless of the touch screen, the structure of the terminal becomes complicated.

In addition, the terminal in the prior art has another problem in that an additional button type input device 14 is required even though the touch screen is provided as the input device as shown in FIG. 1. The button type input device 14 makes the structure of the terminal complicated.

### SUMMARY OF THE INVENTION

The present invention has been made in an effort to provide a touch screen including a first touch screen part providing absolute coordinate information of a contact point by detecting external contact of an input device and computing a coordinate of the contact point and a second touch screen part providing vector coordinate information of the input device so as to control a pointer display on a display by measuring the change in capacitance depending on the external contact of the input device.

A touch screen according to a preferred embodiment of the present invention includes: a first touch screen part that is positioned on an upper part of a display to detect external contact of an input device and compute absolute coordinate information of a contact point and includes two substrates having electrodes patterns that are spaced by a spacer and face each other; and a second touch screen part that is connected with the first touch screen part to measure the change in capacitance by the external contact of the input device and compute vector coordinate information of the input device.

Further, the second touch screen part includes a base member, a plurality of sensing patterns that are formed one surface of the base member and separated by a plurality of slits that cross each other, and sensing wires connected with the sensing patterns.

In addition, the slits of the second touch screen part are constituted by two slits and the plurality of sensing patterns are constituted by four sensing patterns.

Two slits have a diagonal shape.

Two slits have an orthogonal line shape.

The sensing patterns have a polygonal shape.

The plurality of sensing patterns have the same area or shape.

The sensing patterns are made of a conductive polymer.

The second touch screen part further includes a protective layer covering the sensing patterns and the sensing wires.

The second touch screen part further includes button patterns that are disposed at the sides of the sensing patterns to measure the change in capacitance by the external contact of the input device and button wires connected with the button patterns.

The second touch screen part further includes a control unit connected with the sensing wires and the control unit computes vector coordinate information depending on capacitance ratios of the input device and the plurality of sensing patterns.

The second touch screen part further includes the control unit connected with the sensing wires and the control unit outputs a button input signal when the capacitances generated in the plurality of sensing patterns at the same time is a reference value or more.

The second touch screen part further includes the control unit connected with the sensing wires and the control unit controls movement of a pointer by measuring the change in capacitance generated in the plurality of sensing patterns as the input device moves.

In the base member, a substrate disposed on the upper part of the first touch screen part extends, and the sensing patterns and the sensing wires are formed outside of an active region through which an image generated in the display passes.

In the base member, the spacer of the first touch screen part extends, and the sensing patterns and the sensing wires are formed outside of the active region through which the image generated in the display passes.

### BRIEF DESCRIPTION OF THE DRAWINGS

FIG. 1 is a plan view illustrating a cellular phone as a terminal with a touch screen in the prior art;

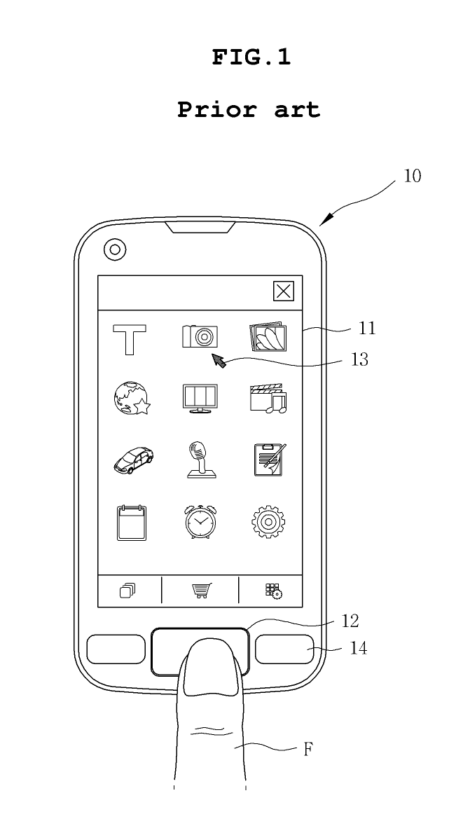

FIG. 2 is a plan view schematically showing a touch screen according to the present invention;

FIG. 3 is a cross-sectional view showing a first touch screen part of a touch screen shown in FIG. 2;

FIG. 4 is a plan view showing a second touch screen part of a touch screen shown in FIG. 2;

FIGS. 5 and 6 are plan views showing a modified example of a touch screen shown in FIG. 4;

FIGS. 7 to 9 are cross-sectional views of a touch screen shown in FIG. 2;

FIG. 10 is a block diagram schematically showing the structure of a touch screen according to the present invention; and

FIGS. 11 and 12 are diagrams showing a method for a control unit connected to a second touch screen part shown in FIG. 10 to measure the change in capacitance of an input device and a second touch screen.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the subject of the present invention.

Hereinafter, preferred embodiments of the present invention will be described in detail with reference to the accompanying drawings.

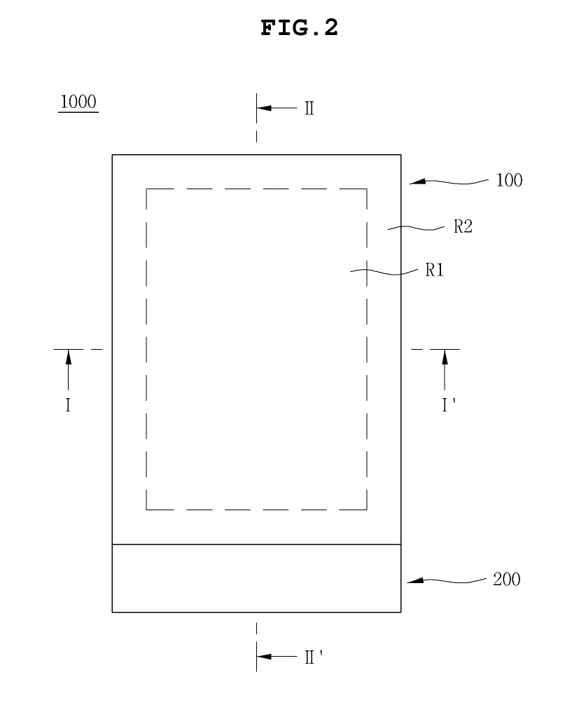

FIG. 2 is a plan view schematically showing a touch screen according to the present invention. Hereinafter, the touch screen according to the embodiment of the present invention will be described with reference to FIG. 2.

The touch screen 1000 according to the present invention includes a first touch screen part 100 that is positioned on an upper part of a display to detect external contact and computes a coordinate of a contact point and a second touch screen part 200 that is connected with the first touch screen part 100 to measure the change in capacitance depending on external contact of an input device and computes vector coordinate information of the input device.

The first touch screen part 100 is divided into an active region R1 through which an image passes and an inactive region R2 through which the image does not pass, as shown in FIG. 2. In the active region R1, an electrode pattern is formed and the external contact is detected and in the inactive region R2, an electrode wire, which transfers the change in voltage or the change in capacitance generated in the electrode pattern to the control unit, is formed.

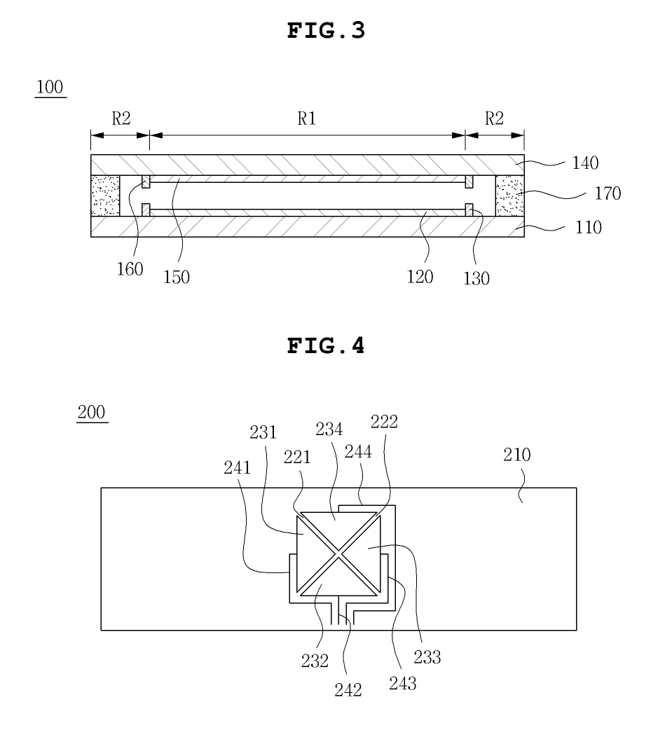

FIG. 3 is a cross-sectional view of a touch screen taken along the line I-I′ of FIG. 2. Referring to FIG. 3, the structure of the first touch screen part 100 which may be adopted in the embodiment of the present invention will be described. A resistive touch screen is shown in FIG. 3, but a capacitive touch screen may be adopted as the first touch screen part 100.

The first touch screen part 100 is spaced by a spacer and includes two substrates having electrode patterns that face each other.

At this time, a first electrode pattern 120 is formed in the active region R1 and a first electrode wire 130 connected with the first electrode pattern 120 is formed in the inactive region R2, in a first substrate 110 that is disposed in a lower part. At this time, the first substrate 110, as a transparent flat member, may adopt a glass substrate, a film substrate, a fiber substrate, and a paper substrate. Among them, the film substrate may be made of polyethylene terephthalate (PET), polymethylemethacrylate (PMMA), polypropylene (PP), polyethylene (PE), polyethylenenaphatalenedicarboxylate (PEN), polycarbonate (PC), polyethersulfone (PES), polyimide (PI), polyvinylalcohol (PVA), cyclic olefin copolymer (COC), stylene polymer, polyethylene, polypropylene, etc. and is not particularly limited.

Further, the first electrode pattern 120 is made of an ITO, a carbon nanotube, and a conductive polymer and the conductive polymer may adopt polythiophene, polypyrrole, polyaniline, polyacetyl, polyphenylene polymers, as organic compounds. In particular, among the polythiophene-based compounds, a PEDOT/PSS compound is most preferable and one or more kinds of compounds among the organic compounds may be mixed and used. At this time, in the case of the resistive touch screen, the first electrode pattern 120 has a thin-film shape.

Further, the first electrode wire 130 is connected with the first electrode pattern 120 and transfers the change in voltage generated by contact of the electrode pattern to a control unit (not shown). The first electrode wire 130 may be made of the same material as the first electrode pattern 120 or it may be made of silver (Ag).

In a second substrate 140 disposed in an upper part, a second electrode pattern 150 faces the first electrode pattern 120 and a second electrode wire 160 connected with the second electrode pattern 150 is formed in the inactive region R2 disposed outside of the active region R1.

The second electrode pattern 150 and the second electrode wire 160 may have the same materials and functions as the first electrode pattern 120 and the first electrode wire 130. Therefore, detailed description thereof will be omitted. However, the second electrode wire 160 is generally formed in a direction different from the first electrode wire 130.

A spacer 170 that allows the first electrode pattern 120 and the second electrode pattern 150 to be spaced from each other is positioned between the first substrate 110 and the second substrate 140. In the case in which the first touch screen part 100 is the resistive touch screen as shown in FIG. 3, the spacer 170 has a structure in which an inner portion of the spacer 170 is opened. Therefore, the first electrode pattern 120 and the second electrode pattern 150 contact with each other by external force and as a result, the change in voltage is measured to detect a coordinate of a contact point.

Meanwhile, in the case in which the first touch screen part 100 according to the present invention is the capacitive touch screen, the spacer 170 is constituted by a transparent flat member that can completely space the first electrode pattern 120 and the second electrode pattern 150 from each other and the first electrode pattern 120 and the second electrode pattern 150 are formed by a plurality of patterns having different directionalities, as a result, the number of electrode wires is also increased. The structure of the capacitive touch screen is already known. Therefore, a detailed description thereof will be omitted.

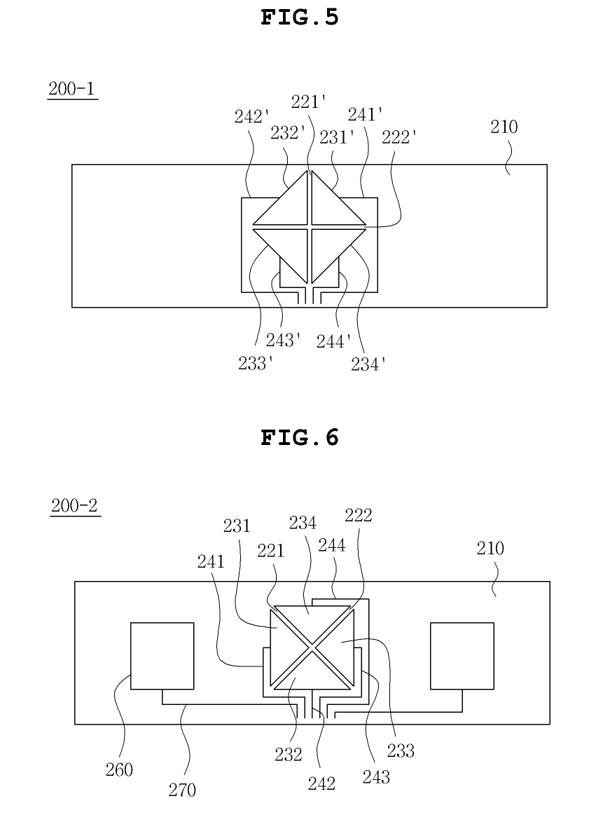

FIG. 4 is an enlarged plan view of a second touch screen part of a touch screen shown in FIG. 2 and FIGS. 5 and 6 are plan views showing a modified example of a second touch screen part shown in FIG. 4. Hereinafter, the second touch screen part 200 according to the embodiment of the present invention will be described with reference to the figures.

The second touch screen part 200 according to the embodiment of the present invention includes a base member, a plurality of sensing patterns 230 that are formed on one surface of the base member and formed by a plurality of slits 220 that cross each other, and sensing wires 240 connected with the sensing patterns 230, as shown in FIG. 4.

The base member 210 may adopt the glass substrate, the film substrate, the fiber substrate, the paper substrate, etc. Since the image generated in the display does not pass through the base member 210, the base member 210 does not need to be configured with a transparent member. The sensing pattern 230 is formed on one surface of the base member 210 as described below and the other surface constitutes a contact surface that contacts with the input device. At this time, the base member 210 serves as a dielectric.

The second touch screen part 200 measures the change in capacitance depending on contact of a user's finger or the input device such as a stylus pen and includes the plurality of sensing patterns separated by the plurality of slits. In FIG. 4, four sensing patterns 230, that is, 231 to 234 separated by two slits 220, that is, 221 and 222 that cross each other are shown as a preferred embodiment.

At this time, the sensing pattern 230 is made of conductive materials such as the ITO, the carbon nanotube, and the conductive polymer. When the sensing pattern 230 contacts with the input device with the dielectric interposed therebetween, the change in capacitance generated between the sensing pattern 230 and the input device is measured to compute vector coordinate information of the input device. In particular, the sensing pattern 230 is preferably made of the conductive polymer like the electrode pattern of the first touch screen part 100. The conductive polymer is easily formed in a desired shape by an inkjet printing method or a gravure printing method and thus, saves manufacturing cost in comparison with other conductive materials.

In addition, as shown in FIG. 4, two slits 220, that is, 220-1 and 220-2 that cross each other preferably have a diagonal shape. As a result, a first sensing pattern 231 and a third sensing pattern 233 positioned at the left side and the right side and a second sensing pattern 232 and the fourth sensing pattern 234 positioned at the upper side and the lower side on the basis of a cross-point (formed by two slits) are separated from each other.

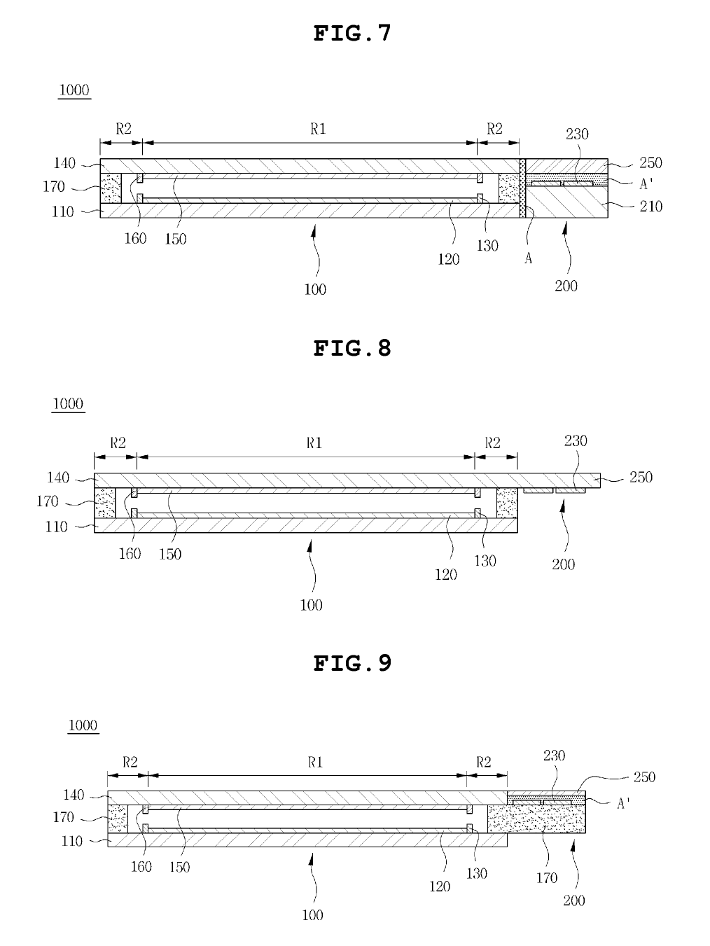

At this time, in the case in which two slits 220′, that is, 221′ and 222′ that cross each other is an orthogonal line shape, a first sensing pattern 231′ positioned on a first quadrant to a fourth sensing pattern 234′ positioned at a fourth quadrant on the basis of the cross-point are separated from each other as shown in FIG. 5.

The sensing patterns 230 separated by two slits 220 that cross each other preferably have a polygonal shape. The sensing patterns 230 shown in FIGS. 4 and 5 have a triangular shape, but is not limited thereto and may have a rectangular shape, etc. However, the sensing patterns 230 have the triangular shape or the rectangular shape so as to easily form the plurality of sensing patterns and accurately measure the change in capacitance.

Further, fourth sensing patterns 230 have the same area. The area of the sensing patterns 230 is the key factor to determine capacitance generated between the input device and the sensing pattern 230 and the intensity of the capacitance depends on the area of the sensing pattern 230. For example, even though the input device contacts with the first sensing pattern 231 and the second sensing pattern 232 of the second touch screen part 200 with the dielectric therebetween at the same area ratio, areas of the sensing patterns 230 are different from each other. Therefore, in the case in which an area of a region of the second sensing pattern 232 which does not contact with the input device is much larger than that of the first sensing pattern 231, an error that capacitance between the second sensing pattern 232 and the input device is measured to be substantially larger than the capacitance between the first sensing pattern 231 and the input device may occur due to parasitic capacitance generated between the region that does not contact with the input device and the input device.

In the case in which fourth sensing patterns 230 have the same area, the parasitic capacitance of the region that does not contact with the input device are evenly formed on four sensing patterns, thereby preventing such an error.

Further, in the case in which four sensing patterns 230 have the same shape, the sensing patterns have the same area and even an influence of the parasitic capacitance generated by the shapes of the sensing patterns is removed, thereby acquiring more accurate vector coordinate information.

In addition, the second touch screen part 200 includes the sensing wires 240 connected with the sensing patterns 230. The sensing wires 240, that is, 241 to 244 transfer the change in capacitance generated in the sensing patterns 230 and ends of the sensing patterns are preferably collected at one portion of the base member 210. The sensing wires 240 collected at one portion is connected to a control unit (not shown) controlling the second touch screen part 200 through a connection device such as an FPC (not shown).

The sensing wires 240 are also made of the conductive material. The sensing wires 240 are preferably made of the same material as the sensing patterns 230 or a material having low sheet resistance such as silver (Ag).

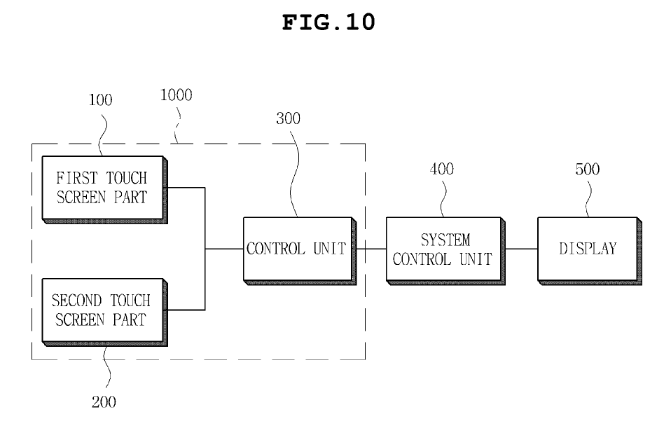

In addition, the second touch screen part 200 may further include a protective layer 250 (see FIG. 7) covering the sensing wires 240 connected with the sensing patterns 230. The protective layer is disposed between the sensing patterns 230 and the input device to serve as the dielectric that causes the change in capacitance and protect the sensing patterns and the sensing wires from the outside. Therefore, in the case in which the protective layer is formed in the second touch screen part 200, any one of the base member 210 and the protective layer constitutes the external surface of the touch screen according to the embodiment of the present invention.

Further, in the case in which the protective layer constitutes an external surface that contacts with the input device, a direction indicating symbol indicating the direction of a pointer may be printed. The protective layer as the transparent member may be made of the glass substrate or the film substrate and adheres to the base member 210 while covering the sensing patterns 230 and the sensing wires 240 by an adhesive.

The second touch screen part 200 according to the embodiment of the present invention may further include button patterns 260 and button wires 270 that are disposed at the sides of the sensing pattern 230 to measure the change in capacitance by external contact of the input device as shown in FIG. 6.

The sensing pattern 230 controls movement of the pointer, while when the pointer moves to a desired icon, the button pattern 260 serves to perform a button input function for selecting the corresponding icon. The terminal adopting the touch screen in the prior art is provided with an additional button type input device in order to perform such a function. However, as a result, the structure of the terminal becomes complicated. The button pattern 260 according to the embodiment of the present invention may substitute for the button-type input device mounted on the terminal in the prior art to thereby improve the degree of design freedom of the terminal.

In the case in which the input device is positioned on the button pattern 260 with the base member 210 or the protective layer interposed therebetween, capacitance is increased. In this case, the control unit outputs a button input signal by detecting the increased capacitance. The button pattern 260 may be made of the conductive material like the sensing patterns 230 and the shape of the button pattern 260 is not limited to a predetermined shape. However, the button pattern 260 is spaced from the sensing pattern 230 to thereby prevent parasitic capacitance from being generated between the button pattern 260 and the sensing pattern 230.

The button wires 270 also transfers the change in capacitance generated in the button pattern 260 to the control unit and may be made of the same material as the sensing wires 240. Ends of the button wires 270 are preferably collected at one portion of the base member 210 like the ends of the sensing wires 240.

FIGS. 7 to 9 are cross-sectional views of a touch screen 1000 taken along the line II-II′ of FIG. 2. Herein, a connection structure of the first touch screen part 100 and the second touch screen part 200 will be described with reference to the figures.

First, as shown in FIG. 7, one portion of the first touch screen part 100 and one portion of the second touch screen part 200 are coupled with each other by an adhesive A to have an integrated shape.

At this time, the second touch screen part 200 further includes the protective layer 250 that covers the sensing patterns 230 and the sensing wires 240 and is formed in the base member 210 by an adhesive A′. The second touch screen part 200 is just one example. In the case in which the base member 210 serves as the dielectric and constitutes the external surface of the touch screen, the base member 210 which is faced downward without the protective layer 250 in the second touch screen part 200 shown in FIG. 7 may be coupled with the first touch screen part 100 by the adhesive.

Next, as shown in FIG. 8, in the base member 210, the second substrate 140 disposed on the upper part of the first touch screen part 100 extends, and the sensing patterns 230 and the sensing wires 240 may be formed in an extension region of the substrate. As a result, the sensing patterns 230 and the sensing wires 240 are formed in the inactive region that is disposed outside the active region through which the image generated in the display passes.

In the case of the touch screen shown in FIG. 8, since the base member 210 of the second touch screen part 200 is substituted by the second substrate 140 disposed on the upper part of the first touch screen part 100, manufacturing cost is decreased, and the first touch screen part 100 and the second touch screen part 200 are integrated with each other, as a result, the structure becomes simple and robust.

Meanwhile, although the sensing patterns 230 are formed on the bottom of the second substrate 140 disposed on the upper part in FIG. 8, the sensing patterns 230 may be formed on the top of the substrate 140 and the protective layer covering the sensing patterns 230 and the sensing wires 240 may be formed.

Further, as shown in FIG. 9, in the base member, the spacer 170 of the first touch screen part 100 extends, and the sensing patterns 230 and the sensing wires 240 may be formed in an extension region of the spacer. As a result, the sensing patterns 230 and the sensing wires 240 are formed in the inactive region that is disposed outside of the active region through which the image generated in the display passes. The sensing patterns 230 and the sensing wires 240 are formed on the top of the spacer 170. The protective layer 250 covering the sensing patterns 230 and the sensing wires 240 is coupled with the spacer 170 by the adhesive A′ to form the contact surface of the input device. At this time, the top of the protective layer 250 preferably forms a flat surface with the top of the second substrate 140.

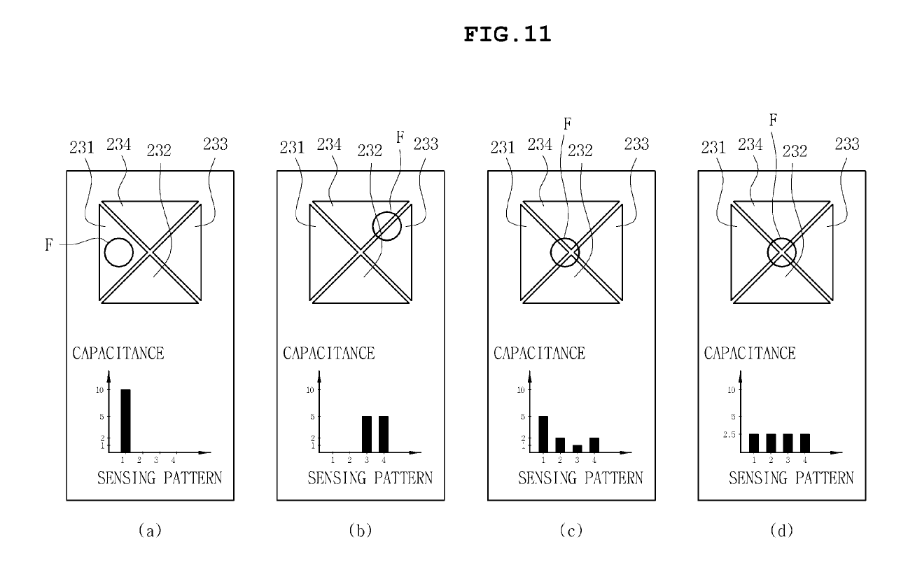

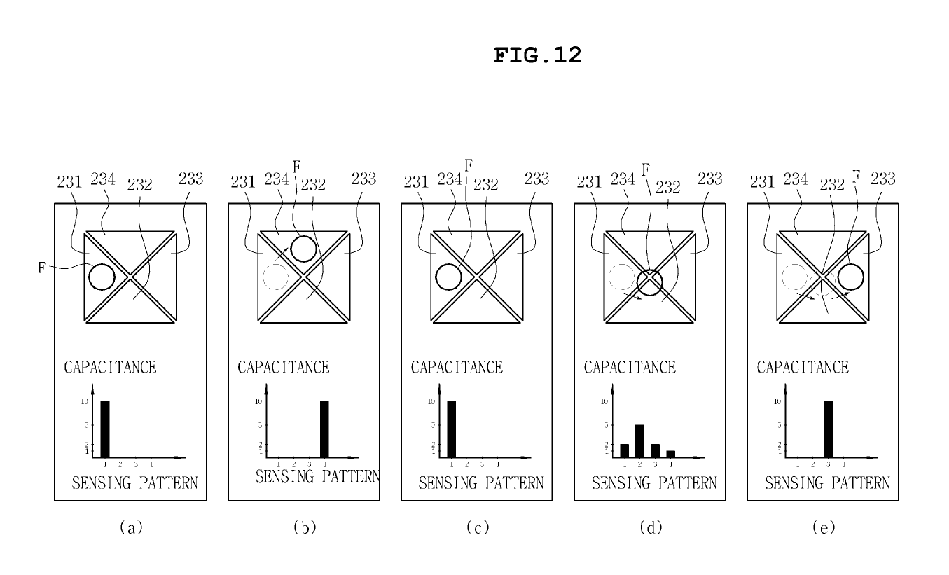

FIG. 10 is a block diagram schematically showing the structure of a terminal mounted with a touch screen according to the present invention, and FIGS. 11 and 12 are diagrams showing a method for a control unit connected to a second touch screen part shown in FIG. 10 to measure the change in capacitance of the second touch screen part. Hereinafter, a method for controlling a touch screen according to an embodiment of the present invention will be described with reference to the figures.

The terminal mounted with the touch screen according to the embodiment of the present invention includes a touch screen 1000 including a first touch screen part 100, a second touch screen part 200, and a control unit 300 controlling the touch screen, a system control unit 400 operating the entire terminal, and a display 500 as shown in FIG. 10. Although not shown in FIG. 10, the terminal further includes a wireless communication unit, a broadcast receiving unit, an audio input/output unit, etc., depending on the type of the terminal.

The control unit 300 of the touch screen 1000 includes an analog/digital converter converting an analog signal into a digital signal depending on the change in voltage or the change in capacitance generated in the first touch screen part 100. In addition, the control unit 300 converts the digital signal into absolute coordinate information and vector coordinate information by a coordinate conversion algorithm or a vector conversion algorithm and transmits them to the system control unit 400.

The system control unit 400 transmits the absolute coordinate information and the vector coordinate information to the display 500 and in the case in which the display 500 receives the absolute coordinate information, the system control unit 400 provides an image having the corresponding information and in the case in which the display 500 receives the vector coordinate information, the system control unit 400 controls a pointer on the basis of the vector coordinate information.

A method for the control unit to measure the change in capacitance of an input device and the second touch screen part 200 will be described with reference to FIGS. 11 to 13.

At this time, the second touch screen part having the sensing pattern 230 having the shape shown in FIG. 4 will be described as one example. Four sensing patterns 230 include a first sensing pattern 231 positioned at the left side, a second sensing pattern 232 positioned at a lower part, a third sensing pattern 233 positioned at the right side, and a fourth sensing pattern 234 positioned at an upper part on the basis of a cross-point formed by two slits 220. Meanwhile, the second touch screen part will be described on the basis of a case in which the maximum capacitance formed by the input device F and the sensing patterns 230 is 10. In addition, an expression that ‘the input device F contacts with the sensing patterns 230’ to be described below means that a dielectric such as the base member or the protective layer is positioned between the input device F and the sensing pattern 230 and the input device substantially contacts with the dielectric.

First, as shown in FIG. 11, the control unit 300 generates the vector coordinate information depending on capacitance ratios of an input device (not shown) and four sensing patterns 230. The vector coordinate information generated by the control unit 300 is transmitted to the display 500 and as a result, movement of the pointer is controlled.

At this time, as shown in FIG. 11A, when an input device F is positioned on a first sensing pattern 231 with a base member (not shown) or a protective layer (not shown) serving as the dielectric, which is interposed therebetween, capacitance is increased and as a result, the capacitance has a value of 10. Since the capacitance is not increased in the second sensing pattern 232, the third sensing pattern 233, and the fourth sensing pattern 234, capacitance generated in four sensing patterns 230 have a ratio of 1:0:0:0. Therefore, the control unit generates and transmits left vector coordinate information to the system control unit 400 and transfers the information to the display 500, and the pointer moves left. As such, in the case in which the input device F is positioned on only one sensing pattern among four sensing patterns 230, the control unit 300 generates upper/lower and left/right vector coordinate information.

Further, as shown in FIG. 11B, even though the capacitance substantially varies on only two sensing patterns in the case in which the input device F contacts with two adjacent sensing patterns, the vector coordinate information is generated depending on the capacitance ratio of four sensing patterns 230. As shown in FIG. 11B, in the case in which the input device F contacts with the third sensing pattern 233 and the fourth sensing pattern 234 while forming the same contact area on the third sensing pattern 233 and the fourth sensing pattern 234, the capacitance ratio generated in four sensing patterns is 0:0:1:1. Therefore, the control unit generates vector coordinate information having a diagonal direction between a right direction and an upward direction and transmits the generated vector coordinate information to the system control unit. As a result, the pointer moves in the diagonal direction between the right direction and the upward direction.

At this time, in the case in which the capacitance ratio is 0:0:3:2 because the input device F has a larger contact area on the third sensing pattern 233, the pointer generates the vector coordinate information of the diagonal direction formed upwards at approximately 36° from the right direction. At this time, a directionality of the vector coordinate information is in proportion to the contact area of the input device F formed in the sensing pattern and in the case in which the capacitance ratio is 0:0:3:2 as described above, the directionality of the vector coordinate information has the right direction at the corresponding ratio.

Next, as shown in FIG. 11C, a case in which the input device F contacts with three or more sensing patterns will be described. As described above, the contact area of the input device F that contacts with the sensing patterns 230 controls the direction of the pointer and in the case in which the capacitance ratio generated in four sensing patterns 230 is 5:2:1:2 as shown in FIG. 11C, the control unit generates the left vector coordinate information. At this time, the second sensing pattern 232 and the fourth sensing pattern 234 have the same capacitance ratio so as not to influence the directionality of the vector coordinate information and the vector coordinate information is determined depending on the capacitance ratio of the first sensing pattern 231 and the third sensing pattern 233.

Meanwhile, the control unit 300 generates the vector coordinate information in proportion to a contact time of the input device F to the sensing patterns 230 and when the input device F is spaced from the sensing patterns 230, the control unit 300 does not generate the vector coordinate information any longer.

At this time, as shown in FIG. 11D, in the case in which the capacitances generated in four sensing patterns have a reference value or more, the control unit generates a button input signal.

The button input signal is generated when the input device F contacts with center portions of the sensing patterns 230. When the input device F accurately contacts with the center portions of the sensing patterns 230, all the capacitances of the first sensing pattern 231 to the fourth sensing pattern 234 have a value of 2.5. When all four sensing patterns 230 have the capacitance value of 2.5, the input device F performs button input. However, it is substantially difficult to accurately contact the input device F to the center portion of the sensing patterns 230. Therefore, a capacitance generated when button input is generally performed through the input device F is set as the reference value and when the capacitances generated in four sensing patterns 230 are equal to or larger than the reference value, the control unit 300 preferably generates the button input signal.

At this time, the reference value is determined by considering generation of the vector coordinate information described with reference to FIG. 11C. For example, when the contact shown in FIG. 11C occurs in the case in which the reference value is 2, the control unit 300 then generates the left vector coordinate information without generating the button input signal.

In addition, as shown in FIG. 12, the control unit 300 may generate the vector coordinate information by measuring the change in capacitance generated in four sensing patterns 230 as an input device (not shown) moves. The vector coordinate information generated by the control unit 300 is transmitted to the display and as a result, movement of the pointer is controlled.

As shown in FIGS. 12A and 12B, when the input device F moves, the control unit generates the vector coordinate information having the diagonal direction between the right direction and the upward direction and transmits the generated vector coordinate information to the system control unit 400. As a result, the pointer moves in the diagonal direction between the right direction and the upward direction.

In FIGS. 12A and 12B, the input device F moves on two sensing patterns and the input device F contacts with the first sensing pattern 231 to generate the capacitance and as the input device F moves, the capacitance of the first sensing pattern 231 decreases and the capacitance of the fourth sensing pattern 234 increases. The control unit 300 measures the change in capacitance generated in the sensing patterns 230 and generates vector coordinate information depending on a movement path of the input device. If the input device F moves from the fourth sensing pattern 234 to the first sensing pattern 231, the control unit 300 generates vector coordinate information opposite to the above-mentioned vector coordinate information.

The control unit 300 generates the corresponding vector coordinate information similarly even in a case in which the input device F moves from the second sensing pattern 232 to the third sensing pattern 233. Further, when the input device moves from the fourth sensing pattern 234 to the third sensing pattern 233, the control unit 300 generates vector coordinate information having the diagonal direction between the right direction and the downward direction and even when the input device moves from the first sensing pattern 231 to the second sensing pattern 232, the control unit 300 also generates the corresponding vector coordinate information.

Referring to FIGS. 12C to 12E, a case in which the input device moves on three or more sensing patterns when the input device moves will be described. For example, when the input device F moves from the first sensing pattern 231 to the third sensing pattern 233, the input device F may move through the second sensing pattern 232 or the fourth sensing pattern 234.

At this time, the change in capacitance generated in the sensing patterns 230 is shown in FIGS. 12C to 12E. First, when the input device F is positioned in the first sensing pattern 231 and thereafter moves to the third sensing pattern 233 through the cross-point, the input device F may be positioned on four sensing patterns 230 as shown in FIG. 12D. Since the input device F moves from the first sensing pattern to the third sensing pattern 233 within a short time, capacitance formed in FIG. 12D does not influence the vector coordinate information generated by the control unit 300 and capacitance generated in the third sensing pattern 233 in which the input device F is finally positioned influences the vector coordinate information. That is, when the input device F moves on three or more sensing patterns, the vector coordinate information is generated on the basis of capacitances generated in a sensing pattern of a first contact point and a sensing pattern of a final contact point. Accordingly, as shown in FIGS. 12C to 12E, the control unit generates right vector coordinate information. To the contrary, when the input device F moves from the third sensing pattern 233 to the first sensing pattern 231 through the cross-point, the control unit generates the left vector coordinate information.

Further, when the input device F moves from the second sensing pattern 232 to the fourth sensing pattern 234 through the cross-point, the control unit generates upward vector coordinate information and in the reverse case, the control unit generates downward vector coordinate information.

According to the present invention, it is possible to control a pointer displayed on a display and facilitate fine tuning using the pointer by providing vector coordinate information of an input device by measuring the change in capacitance depending on external contact of the input device without an additional pointing device.

Further, the touch screen according to the present invention can perform a button input by measuring change in capacitance, thereby making it possible to remove a button type input device required outside a terminal.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A touch screen, comprising:
a first touch screen part that is positioned on an upper part of a display to detect external contact of an input device and compute absolute coordinate information of a contact point and includes two substrates having electrodes patterns that are spaced by a spacer and face each other; and
a second touch screen part that is connected with the first touch screen part to measure the change in capacitance by the external contact of the input device and compute vector coordinate information of the input device.

2. The touch screen as set forth in claim 1, wherein the second touch screen part includes a base member, a plurality of sensing patterns that are formed one surface of the base member and separated by a plurality of slits that cross each other, and sensing wires connected with the sensing patterns.

3. The touch screen as set forth in claim 2, wherein the slits of the second touch screen part are constituted by two slits and the plurality of sensing patterns are constituted by four sensing patterns.

4. The touch screen as set forth in claim 3, wherein two slits have a diagonal shape.

5. The touch screen as set forth in claim 3, wherein two slits have an orthogonal line shape.

6. The touch screen as set forth in claim 2, wherein the sensing patterns have a polygonal shape.

7. The touch screen as set forth in claim 2, wherein the plurality of sensing patterns have the same area or shape.

8. The touch screen as set forth in claim 2, wherein the sensing patterns are made of a conductive polymer.

9. The touch screen as set forth in claim 2, wherein the second touch screen part further includes a protective layer covering the sensing patterns and the sensing wires.

10. The touch screen as set forth in claim 2, wherein the second touch screen part further includes button patterns that are disposed at the sides of the sensing patterns to measure the change in capacitance by the external contact of the input device and button wires connected with the button patterns.

11. The touch screen as set forth in claim 2, wherein the second touch screen part further includes a control unit connected with the sensing wires and the control unit computes vector coordinate information depending on capacitance ratios of the input device and the plurality of sensing patterns.

12. The touch screen as set forth in claim 2, wherein the second touch screen part further includes the control unit connected with the sensing wires and the control unit outputs a button input signal when the capacitances generated in the plurality of sensing patterns at the same time is a reference value or more.

13. The touch screen as set forth in claim 2, wherein the second touch screen part further includes the control unit connected with the sensing wires and the control unit controls movement of a pointer by measuring the change in capacitance generated in the plurality of sensing patterns as the input device moves.

14. The touch screen as set forth in claim 2, wherein in the base member, a substrate disposed on the upper part of the first touch screen part extends, and the sensing patterns and the sensing wires are formed outside of an active region through which an image generated in the display passes.

15. The touch screen as set forth in claim 2, wherein in the base member, the spacer of the first touch screen part extends, and the sensing patterns and the sensing wires are formed outside of the active region through which the image generated in the display passes.
